(19) United States
(12) Patent Application Publication
(10) Pub. No.: US 2019/0188903 A1
(43) Pub. Date: Jun. 20, 2019

(54) METHOD AND APPARATUS FOR PROVIDING VIRTUAL COMPANION TO A USER

(71) Applicant: JRD COMMUNICATION (SHENZHEN) LTD, Shenzhen (CN)

(72) Inventor: Li Liu, Shenzhen (CN)

(21) Appl. No.: 16/282,334

(22) Filed: Feb. 22, 2019

Related U.S. Application Data
(63) Continuation of application No. PCT/CN2017/103968, filed on Sep. 28, 2017.

(30) Foreign Application Priority Data
Nov. 15, 2016 (CN) 201611036528.X

(51) Int. Cl. G06T 17/00; G03H 1/02; G06T 19/00; G10L 17/26; G10L 25/63; G06K 9/00

(52) U.S. Cl. CPC G06T 17/00; G03H 1/02; G06T 19/00; G03H 2001/0204; G10L 25/63; G06K 9/00342; G06K 9/00315; G10L 17/26

(57) ABSTRACT

The present disclosure provides a method and an apparatus for providing a user companion by using mixed reality technology. The method includes: receiving from the user a summon indication for summoning a character; summoning the character in response to the summon indication, wherein the character is a virtualized object of a real person; controlling the summoned character to imitate an action or an expression of the real person; receiving from the user an interaction indication with regard to the character; matching the interaction indication against a database to acquire corresponding reaction data of the character; and updating a presentation of the character based on the reaction data. The implementation of the present disclosure may realize the interaction between human and virtual world, which may improve the efficiency and effect of interactivity.

### CROSS-REFERENCE TO RELATED APPLICATIONS

The present application is a continuation-application of International (PCT) Patent Application No. PCT/CN2017/103968, filed on Sep. 28, 2017, which claims foreign priority of Chinese Patent Application No. 201611036528.X, filed on Nov. 15, 2016 in the National Intellectual Property Administration of China, the contents of all of which are hereby incorporated by reference.

### TECHNICAL FIELD

The present disclosure generally relates to mixed reality technology, and in particular to a method and an apparatus for providing virtual companion to a user.

### BACKGROUND

As the virtual reality and the augmented reality mature, a user may choose to experience himself in the virtual world built by computer, or to overlay virtual objects to the real world. However, neither the virtual reality nor the augmented reality can satisfy the demand of interacting between the user and the virtual objects. Thus, the mixed reality technology is created in order to build an interaction and feedback path among the virtual word, the real word and the user. In this way, the user may interact with the virtual world, which may improve the sense of reality the user feels.

### SUMMARY

The present disclosure provides a method and an apparatus for providing virtual companion to a user in order to improve the efficiency and effect of interactivity.

To solve the above mentioned problem, a technical scheme adopted by the present disclosure is to provide a method for providing a user companion by using mixed reality technology. The method includes: receiving from the user a summon indication for summoning a character; summoning the character in response to the summon indication, wherein the character is a virtualized object of a real person; controlling the summoned character to imitate an action or an expression of the real person; receiving from the user an interaction indication with regard to the character; matching the interaction indication against a database to acquire corresponding reaction data of the character; and updating a presentation of the character based on the reaction data.

To solve the above mentioned problem, another technical scheme adopted by the present disclosure is to provide a method for providing virtual companion to a user. The method includes: receiving from the user a summon indication for summoning a character, wherein the character is a virtualized object of a real person; presenting the character to the user in response to the summon indication; controlling the character to imitate an action or an expression of the real person; receiving from the user an interaction indication; matching the interaction indication against a database of reactions of the character to acquire corresponding reaction data of the character; and updating a presentation of the character based on the reaction data.

To solve the above mentioned problem, another technical scheme adopted by the present disclosure is to provide an apparatus for providing virtual companion to a user. The apparatus includes: a processor, a first sensor, a communication circuit and a virtual reality presentation device, wherein the first sensor is configured to collect information from the user for the processor to acquire a summon indication for summoning a character, wherein the character is a virtualized object of a real person; the processor is configured to control the virtual reality presentation device to present the character in response to the summon indication, and to control the character to imitate an action or an expression of the real person; the first sensor is further configured to collect information from the user for the processor to acquire an interaction indication; the processor is further configured to send the interaction indication to a server through the communication circuit, to match the interaction indication against a database of the server to acquire corresponding reaction data of the character, and to control the virtual reality presentation device to update a presentation of the character based on the interaction indication and the corresponding reaction data.

According to the present disclosure, when a user needs companion, the virtualized object of a real person (a character) can be called by a summon indication, and the reaction data may be used for realizing interaction between the virtualized object and the user. Thus, the implementation of the present disclosure may realize interaction between the real and virtual world, and may improve efficiency and effect of interactivity.

### BRIEF DESCRIPTION OF THE DRAWINGS

FIG. 1 is a flow chart of a method for providing a user companion by using mixed reality technology according to an embodiment of the present disclosure.

FIG. 2 is a flow chart of detailed operations of step S11 shown in FIG. 1.

FIG. 3 is a flow chart of a method for establishing the virtualized object described in S12.

FIG. 4 is a flow chart of detailed operations of step S13 shown in FIG. 1.

FIG. 5 is a flow chart of a method for establishing the database described in S14.

FIG. 6 shows a structural diagram of an apparatus for providing a user companion by using mixed reality technology according to an embodiment of the present disclosure.

FIG. 7 shows a structural diagram of a system for providing a user companion by using mixed reality technology according to an embodiment of the present disclosure.

### DETAILED DESCRIPTION

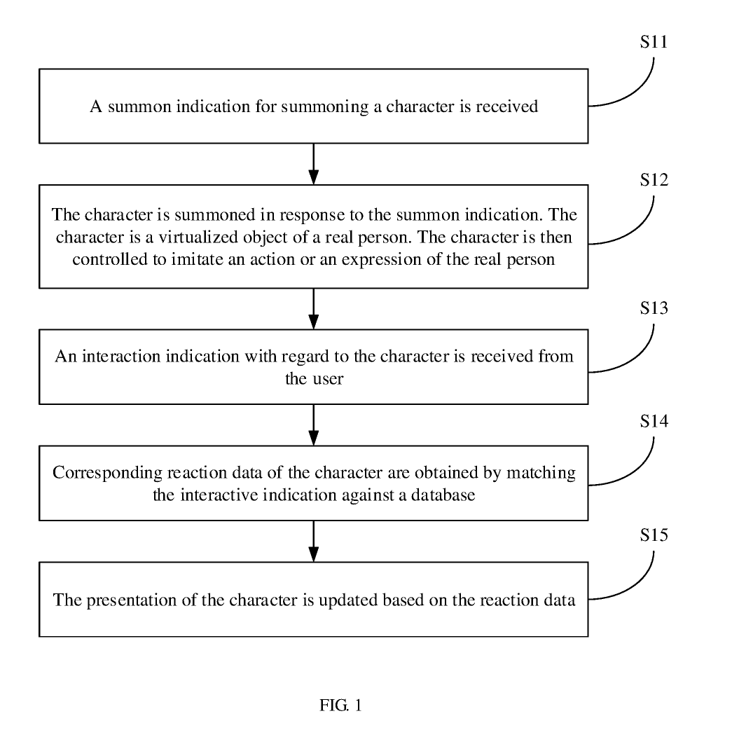

FIG. 1 shows a method for providing a user companion by using mixed reality technology. The method includes operations described in following blocks S11-S15.

S11: A summon indication for summoning a character is received from the user.

When the user needs companion in his daily life, he can put on a smart wearable device and then make a speech, action and/or expression. The smart wearable device may receive the speech, action and/or expression so as to acquire a summon indication for summoning a character from the user. The smart wearable device may be, but is not limited to, a wearable virtual helmet. The smart wearable device may adopt a noise reduction technique for reducing environment noise so as to acquire clearer sound signals.

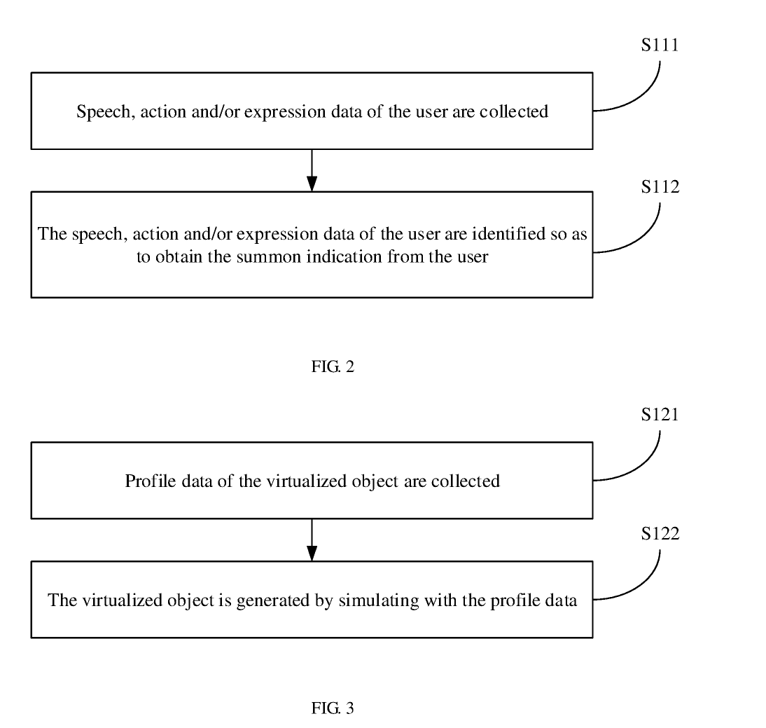

Referring to FIG. 2, the operation of S11 may further include the operations described in following blocks S111 and S112.

S111: Speech, action and/or expression data of the user are acquired.

When the user puts on the device and makes a voice for the first time, the smart device may collect the sound through a microphone. In order to accurately identify the summon indication, action and/or expression data of the user may also be collected through a video acquisition device such as camera when the speech data is acquired.

S112: The speech, action and/or expression data are identified so as to acquire the summon indication.

When the speech is collected, its content may be identified by using semantic recognition technique such that the summon indication may be obtained. Specifically, after the speech is collected, the content may be identified by using semantic recognition technique so as to abstract words as key feature data, e.g., a name of a person. Based on the key feature data, the summon indication of the user which indicates the character to be summoned may be obtained. If action and/or expression data of the user are also collected during the collection of speech data, key actions and/or expression in the action and/or expression data may also be abstracted by using image recognition technique, e.g., waving a hand, crying etc. The summon indication may be identified more accurately by considering the speech, action and/or expression data together.

S12: The character is summoned in response to the indication. The character is a virtualized object of a real person. The character is controlled to imitate an action or an expression of the person.

When the summon indication is identified by the smart wearable device, the character corresponding to the indication may be summoned. The character is a virtualized object of a real person, i.e., a virtual model which is built based on height, weight, measurements, bone-size, facial feature or other parameters. After the character is summoned, it may be controlled to imitate an action or expression of the real person, and it may be presented to the user. For example, the character may be presented by using laser holography technology through the smart wearable device.

The virtualized object corresponding to the character in the indication may be built at a server in advance. FIG. 3 shows the operations for building a virtualized object. The method includes operations described in blocks S121-S122.

S121: Profile data for building the virtualized object are collected.

For building the virtualized object of a real person, the height, weight, measurements, bone-size and other parameters of the person may be collected by sensors, and the facial features of the person may be collected by an image acquisition device.

S122: The profile data may be utilized for simulation so as to generate the virtualized object.

When the profile data are collected, the sensors and the image acquisition device may send to the server those data as well as the identification information of the real person. The server may build a three-dimension model of the real person based on its height, weight, measurements, bone-size or other parameters, and then generate the face of the model by using face recognition technique. Based on the three-dimension model and its facial features, the virtualized object may be built. The virtualized object and corresponding identification information may be stored by the server.

In other embodiment, the virtualized object may be alternatively built by a computer software.

S13: An interaction indication with regard to the character is received from the user.

After the virtualized object is summoned, the smart wearable device may continue to identify speech, action and/or expression data of the user so as to acquire the interaction indication from the user.

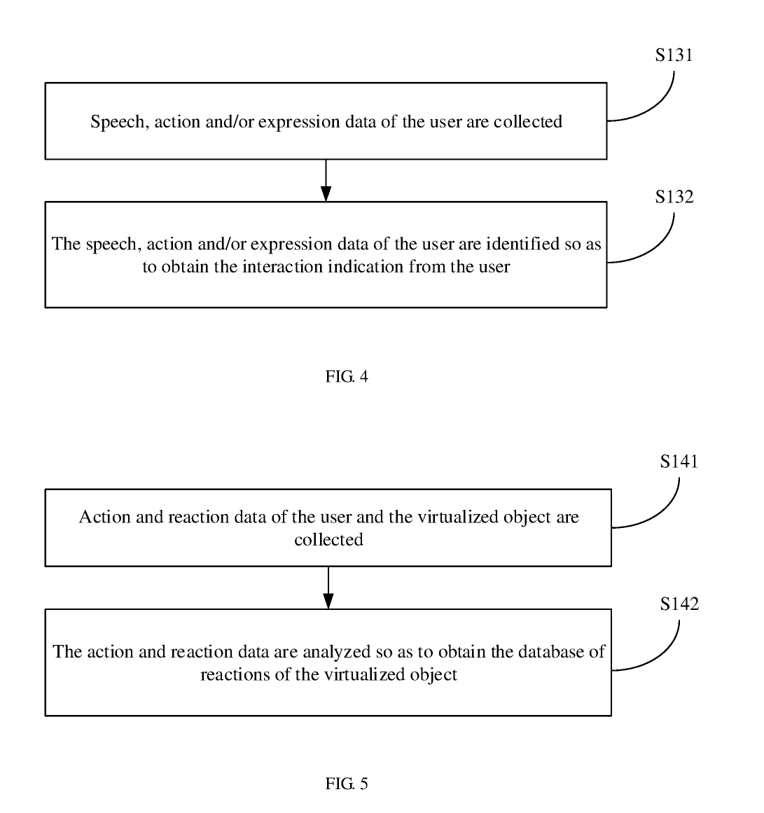

Referring to FIG. 4, the operation of S13 may include operations described in following blocks S131-S132.

S131: Speech, action and/or expression data of the user are collected.

After the virtualized object is summoned, the smart wearable device may continue to collect the speech, action and/or expression data from the user through a microphone and/or a video acquisition device. This operation is similar to that of S111, and will not be repeated herein.

S132: The speech, action and/or expression data are identified so as to obtain the interaction indication from the user.

When the speech is collected, the speech data may be identified by using semantic recognition technique such that the interaction indication may be obtained. Specifically, after the speech is collected, the content may be identified by using semantic recognition technique so as to abstract words as key feature data, e.g., a verb. Based on the key feature data, the interaction indication of the user may be obtained. If action and/or expression data of the user are also collected during the collection of sound data, key actions and/or expression in the action and/or expression may also be abstracted by using image recognition technique, e.g., body movements, emotions, etc. By considering speech, action and/or expression data together, information that the user really wants to provide may be obtained accurately, such that the accurate interaction indication may be acquired.

S14: Corresponding reaction data of the character may be acquired by matching the interaction indication against a database.

After the interaction indication is identified, the interaction indication may be matched against the database of the server so as to search for an identical or similar interaction indication in the database. Then, reaction data of the virtualized object corresponding to the interaction indication may be read. Referring to FIG. 5, the database may be built in the following way.

S141: Action and reaction data of the user and the virtualized object are collected.

The interaction data between the user and the virtualized object may be collected by using a microphone or a video acquisition device in daily life. The data may include actions the user makes and reactions the virtualized object makes in response. The actions may include movements and speeches. The microphone may be of any suitable type. The video acquisition device may include, but is not limited to, a camera. The number and positions of the video acquisition devices are not limited in the present disclosure, and the acquisition area should cover the range of motion of the user and the virtualized object.

S142: The database may be obtained by analyzing the action and reaction data.

After the action and reaction data of the user and the virtualized object are obtained, those data may be uploaded to the server. The server may analyze the data by using big data analysis technique. Based on the analysis of the user's action, indications may be generated. Corresponding reactions (speeches and movements) of the virtualized object in response to those actions may also be recorded. The relation between the indications and the reactions may be stored to form the database.

Action and reaction data may be collected continuously in daily life. Thus, the indications and reaction data in the database may be updated.

S15: The presentation of the character is updated based on the reaction data.

After the reaction data of the virtualized object is read, the presentation of the character may be updated based on the reaction data. That is, the character may be controlled to perform the corresponding reaction. The reaction may include movements and speeches. For example, speeches may be generated through a loudspeaker or an earphone, and movements of the virtualized object may be presented in front of the user by using laser holography technology with the smart wearable device.

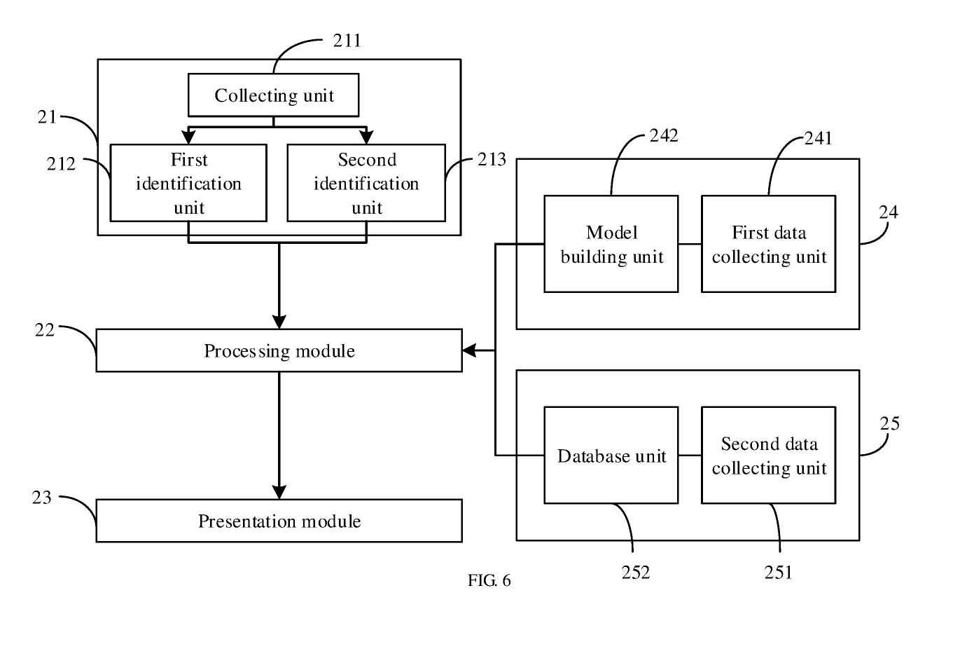

Referring to FIG. 6, FIG. 6 shows an exemplary structure of an apparatus for providing a user companion by using mixed reality technology according to an embodiment of the present disclosure. The apparatus may include a receiving module 21, a processing module 22 and a presentation module 23.

The receiving module 21 may be configured to receive from a user a summon indication for summoning a character, and to receive from the user an interaction indication. The receiving module 21 may include a collecting unit 211, a first identification unit 212 and a second identification unit 213.

The collecting unit 211 may be configured to collect speech, action and/or expression data from the user.

When the user needs companion, he can put on a smart wearable device and then make a speech, action and/or expression. The collecting unit 211 may collect data of the speech, action and/or expression. The collecting unit 211 may include a microphone and/or a video acquisition device. Specifically, after the user speaks, the microphone may collect the speech data. In some embodiments, for accurately identifying the user's indication, action and/or expression data of the user may also be collected with a video acquisition device during the collection of speech data. Furthermore, in order to more clearly collect the speech data, the receiving unit 211 may adopt a noise reduction scheme to reduce environment noise. The microphone may be of any suitable kinds. The video acquisition device may include, but is not limited to, a camera. The position for installing the video acquisition device is not limited as long as its acquisition area covers the upper body of the user.

The first identification unit 212 may be configured to obtain from the user sound indication and/or action indication by using semantic recognition and/or image recognition technique after the collecting unit 211 collects the user's speech, action and/or expression data for the first time. Then the first identification unit 212 may be further configured to obtain the summon indication of the user for summoning a character based on the above indications.

The second identification unit 213 may be configured to continue to collect speech, action and/or expression data after the virtualized object is summoned, and to obtain an interaction indication of the user by using semantic recognition and/or image recognition technique.

The processing module 22 may be configured to search for the virtual model corresponding to the summon indication after the summon indication is received, and to search for reaction data of the character matching the interaction indication after the interaction indication of the user is received.

The presentation module 23 may be configured to present the virtualized object through the smart wearable device by using laser holography technology when the virtual model is matched, and to update the presentation of the character through the smart wearable device by using laser holography technology based on the reaction data so as to control the character to perform corresponding reactions. The reactions may include speeches and movements.

The apparatus may further include a model building module 24 and a database module 25. The model building module 24 may be configured to build the virtual model of the character. The model building module 24 may include a first data collecting unit 241 and a model building unit 242.

The first data collecting unit 241 may include a sensor and an image acquisition device which are utilized to collect real facial features and other parameters such as height, weight, measurements and bone-size of the real person corresponding to the character.

The model building unit 242 may be configured to build the three-dimension model of the character based on the parameters (height, weight, measurements and bone-size), and to generate the face of the character by using face recognition technique so as to build the virtual model of the real person.

The database module 25 may be configured to establish the database. The database module may include a second data collecting unit 251 and a database unit 252.

The second data collecting unit 251 may include a microphone and a video acquisition device (e.g., camera). It may be configured to collect interaction data of the user and the virtualized object through the microphone and the video acquisition device in daily life. Specifically, actions the user makes and reactions the virtualized object makes in response may be recorded.

The database unit 252 may be configured to analyze the collected data in the server by using big data analysis technique, to generate indications based on analysis of the user's actions, to summarize reactions (speeches and movements) made by the virtualized object in response to those actions, and to store the relation between the indications and reactions so as to form the database.

The second data collecting unit 251 may continuously collect the action and reaction data in daily life. Thus, the indications and reaction data in the database unit 251 may also be updated.

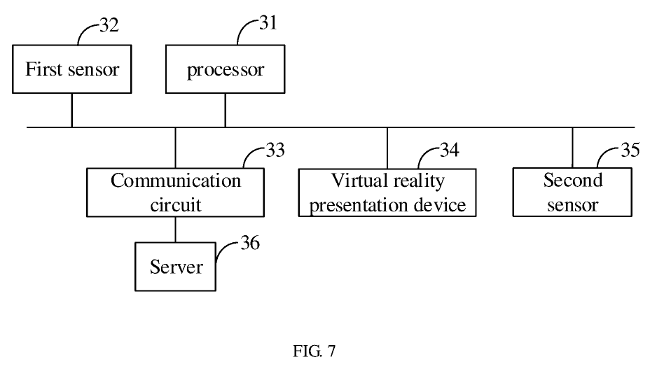

Referring to FIG. 7, FIG. 7 shows a structural diagram of a system for providing a user companion by using mixed reality. The system may include a terminal and a server. The terminal may be configured to execute operations described in the above method. Detailed information may be found in the above embodiments and will not be repeated herein.

In this embodiment, the terminal may include a processor 31, a first sensor 32, a communication circuit 33 and a virtual reality presentation device 34. The first sensor 32, the communication circuit 33 and the virtual reality presentation device 34 are all coupled with the processor 31.

The first sensor 32 may collect information for the processor 31 to acquire the summon indication for summoning a character.

The processor 31 may summon the character in response to the summon indication, and control the virtual reality presentation device 34 to present the character. The character may be a virtualized object of a real person. After the character is summoned, the character may be controlled to imitate an action or an expression of the real person.

The first sensor 32 may continue to collect information for the processor 31 to receive from the user an interaction indication with regard to the character.

The processor 31 may send the interaction indication to the server 36 through the communication circuit 33 so as to obtain corresponding reaction data of the character by matching the interaction indication against the database of the server 36.

The terminal may further include a second sensor 35. The second sensor 35 may be configured to collect interaction speech data between the user and the virtualized character in daily life, to record action and reaction data of the user and the virtualized character in daily life, to photograph the real profile of the real person, and to send these data to the server 36.

The first sensor 32 and the second sensor 35 may be a microphone, a video acquisition device and/or an image acquisition device.

The server 36 may be configured to analyze the speech, action and reaction data by using big data analysis technique to generate a database, to generate a corresponding virtual model of the real person based on the photographed profile of the real person, and to store the database and the virtual model.

According to the present disclosure, the virtual model of the virtualized object and the database of speech, action and reaction data of the virtualized object in daily life may be established in advance. When the user needs companion and sends an indication, the virtual model of the virtualized object may be summoned. Then the presentation of the virtual model may be updated based on speech, action and reaction data in the database. Thus, the implementation of the present disclosure may realize interaction between the real and virtual world, and may improve efficiency and effect of interactivity.

The foregoing is merely embodiments of the present disclosure, and is not intended to limit the scope of the disclosure. Any transformation of equivalent structure or equivalent process which uses the specification and the accompanying drawings of the present disclosure, or directly or indirectly application in other related technical fields, are likewise included within the scope of the protection of the present disclosure.

What is claimed is:

1. A method for providing a user companion by using mixed reality technology, comprising:
receiving from the user a summon indication for summoning a character;
summoning the character in response to the summon indication, wherein the character is a virtualized object of a real person;
controlling the summoned character to imitate an action or an expression of the real person;
receiving from the user an interaction indication with regard to the character;
matching the interaction indication against a database to acquire corresponding reaction data of the character; and
updating a presentation of the character based on the reaction data.

2. The method of claim 1, wherein the virtualized object is acquired by:
collecting profile data for building the virtualized object;
simulating with the profile data to generate the virtualized object.

3. The method of claim 1, wherein the database is acquired by:
obtaining reaction data of the virtualized object;
analyzing the reaction data to acquire the database of the reaction data of the virtualized object.

4. The method of claim 1, wherein the updating the presentation of the character based on the reaction data comprises:
updating the presentation of the character based on the reaction data by using laser holography technology.

5. The method of claim 1, wherein the receiving from the user the interaction indication with regard to the character comprises:
collecting the user's speech, action and/or expression data; and
recognizing the user's speech, action and/or expression data to obtain from the user the interaction indication with regard to the character.

6. A method for providing virtual companion to a user, comprising:
receiving from the user a summon indication for summoning a character, wherein the character is a virtualized object of a real person;
presenting the character to the user in response to the summon indication;
controlling the character to imitate an action or an expression of the real person;
receiving from the user an interaction indication;
matching the interaction indication against a database of reactions of the character to acquire corresponding reaction data of the character; and
updating a presentation of the character based on the reaction data.

7. The method of claim 6, wherein the receiving from the user the summon indication comprises:
collecting speech, action and expression data of the user; and
determining the summon indication based on the speech, action and expression data of the user.

8. The method of claim 6, wherein the receiving from the user the interaction indication comprises:
collecting speech, action and expression data of the user; and
determining the interaction indication based on the speech, action and expression data of the user.

9. The method of claim 6, before the matching the interaction indication against the database of reactions, further comprising:
recording actions of the user and corresponding reactions of the character;
analyzing the actions of the user to generate various indications;
analyzing the reactions of the character corresponding to the actions of the user to generate the reaction data each corresponding to at least one of the various indications; and
storing the various indications, the reaction data and their correspondence relation in the database.

10. The method of claim 9, wherein
the reactions of the character comprise movements and speeches.

11. The method of claim 9, further comprising:
continuing to record actions of the user and reactions of the character in daily life of the user; and
updating the database based on the recorded actions of the user and the recorded reactions of the character.

12. The method of claim 6, before the receiving from the user the summon indication for summoning the character, further comprising:
collecting height, weight, measurements, bone-size and facial features of the real person; and
based on the collected height, weight, measurements, bone-size and facial features of the real person, building a virtual model as the virtualized object of the real person.

13. The method of claim 6, wherein the presenting the character to the user comprises:
presenting the character to the user by using laser holography technology.

14. An apparatus for providing virtual companion to a user, comprising a processor, a first sensor, a communication circuit and a virtual reality presentation device, wherein
the first sensor is configured to collect information from the user for the processor to acquire a summon indication for summoning a character, wherein the character is a virtualized object of a real person;
the processor is configured to control the virtual reality presentation device to present the character in response to the summon indication, and to control the character to imitate an action or an expression of the real person;
the first sensor is further configured to collect information from the user for the processor to acquire an interaction indication;
the processor is further configured to send the interaction indication to a server through the communication circuit, to match the interaction indication against a database of the server to acquire corresponding reaction data of the character, and to control the virtual reality presentation device to update a presentation of the character based on the interaction indication and the corresponding reaction data.

15. The apparatus of claim 14, further comprising a second sensor configured to record actions of the user and reactions of the character;
wherein the database of the server is established based on analysis of the actions of the user and reactions of the character.

16. The apparatus of claim 14, further comprising a second sensor configured to photograph a profile of the real person;
wherein the virtualized object is built by the server based on the profile of the real person.
